(19) United States
(12) Patent Application Publication
(10) Pub. No.: US 2004/0155903 A1
(43) Pub. Date: Aug. 12, 2004

(54) Methods and systems for visualizing categorized information

(76) Inventor: Brian D. Schneeberg, Lovettsville, VA (US)

Correspondence Address: HARNESS, DICKEY & PIERCE, P.L.C., P.O. BOX 8910, RESTON, VA, 20195, US

(21) Appl. No.: 10/735,833

(22) Filed: Dec. 16, 2003

Related U.S. Application Data
(60) Provisional application No. 60/433,590, filed on Dec. 16, 2002.

(51) Int. Cl. G09G 5/00

(52) U.S. Cl. 345/765; 345/745; 345/747

(57) ABSTRACT

Categorized information is presented in a compelling, distilled, pictorial/thematic fashion. Information categories, importance weightings, and status-determining criteria may be defined by a user. A user's custom-defined behaviors are used along with a category's current status, time, and location to present such visual themes. Systems provided by the invention accommodate the interplay between what a given user has defined as important to other trusted users, vendors, and services, both in location and time-sensitive environments. Systems provide a customized look and feel (theme) based on user preferences. Users may, through simple drag-and-drop ‘meta-commands’, affect/make changes to such preferences.

### FIELD OF THE INVENTION

This invention provides methods and systems for visualizing categorized information in a collaborative, interactive context. Technical areas of concentration include Online Analytical Processing (OLAP), Analytics/Informatics, Data Mining and Visualization, Collaborative Computing/Filtering, Artificial Intelligence, and Social Networking.

### BACKGROUND OF THE INVENTION

There are a number of existing factors, the confluence of which has created a need for a system to provide aggregated, distilled information to individuals. These factors may be summarized as follows:

Information is difficult to manage and monitor without a lot of effort;

Sources of information continue to grow at a rapid pace;

People are increasingly required to do more in less time;

Opportunities are missed due to the lack of the right information at the needed time;

Existing portal solutions fail to provide information at a glance.

These issues are present in many diverse domains including, but not limited to, the following:

The Military—Command & Control;

Academia—Collaboration & Reporting;

Intelligence Gathering Organizations—Information Aggregation & Analysis;

Corporations—Business Activity Monitoring;

Consumers—Life Management—Finances, Friends & Family, Forays & Favorites.

This invention seeks to solve these challenges.

### SUMMARY OF THE INVENTION

This invention uses a multi-tiered software and hardware architecture to aggregate and present information as a user-defined pictorial representations via an “analytical dashboard.” The system provides a central controller that is operable to work with such a dashboard and other components of a system to:

Select data feeds emanating from various sources including, in one embodiment, web sites and web services;

Map the data feeds to constituent members of user-defined categories;

Assign to user-defined analytics the constituents to calculate a status based on the data feed value returned;

Assign a weighting to each constituent as to how much of the overall category their status should represent;

Define Boolean constituents whose intent is to unilaterally change a category's overall status depending on the associated data feed(s) value(s) returned;

Assign status ranges and associated behaviors to categories which are comprised of constituents;

Control a graphical user element associated with the category to change (e.g., visually change on an analytical dashboard) in any number of different ways depending on the current status as determined by assessing individual constituent members as well as time and location triggers. In addition, audio behaviors may also be activated. In another embodiment, scents or other types of behaviors may also be activated;

Control the storage of the collection of possible and current graphical user elements along with a background image (e.g., screen-saver) as an interface (i.e., theme) and control the display of such an image on a display (e.g., analytical dashboard) on a GUI.

As a result, users are able to quickly tell the current status for various categories of information due to the associated GUI element being displayed on an analytical dashboard and any behaviors being performed. In addition, when the current status for a given category changes, users also receive ‘popup’ alerts indicating that a change has occurred for that category. Specific types of categories may have additional functionality associated with them. In the current embodiment, Offers have a purchase option associated with them and Friends have a chat function associated with them.

Many of the above-named features are user accessible. The following features are also carried out by parts of a system (e.g., a control unit, etc.):

Users may interact with the interface (e.g., analytical dashboard) and perform specific actions to trigger meta-commands which are linked to user-defined data output parameters;

Meta-commands are automatically based on the current status of a given category;

Users and/or system administrators may publish predefined system objects including, in one embodiment, constituents, categories, and entire interfaces that other users can easily configure and consume in order to expedite setting up a given interface;

Users may drill-down into any category to see the underlying constituents, their associated data feeds, and the originating source web page or other source of data where appropriate;

Systems envisioned by the present invention also include a data mining unit operable to perform data mining on user interests, goals, categories, statuses, etc. and provide value-added feedback as to what other like-minded users are doing while always honoring individual user privacy (i.e., collaborative filtering).

This data mining unit also facilitates social networking capabilities and users are therefore able to interact with these like-minded users if they so choose.

One way social networking is propagated is through the system's capability to seek out other users that are ‘ranked’ in a particular area that a user has an interest in. Users are able to designate networks of other trusted users and the system (e.g., at least the control unit and/or data mining unit) then provides presence awareness as to when these users are online and provides the capability for these users to communicate with one another. Furthermore, trusted users are able to view each other's interfaces to see how they are doing with respect to various categories, typically without the drill-down functionality in the current embodiment for privacy reasons.

In an alternative embodiment, rollups are created, by the control unit or the like, of all of a given user's categories for each interface to arrive at an overall ‘constitution’ for that user which is in turn viewable and consumable by other trusted users.

Vendors are able to utilize the system to deliver targeted offers, opportunities, advice, services, etc. to users based on their interests, goals, categories, or other vendor-definable criteria. Users have the option to provide feedback regarding these vendors using the control unit in conjunction with devices known in the art, thus increasing or decreasing vendor rankings in a given area. Any users may define themselves as vendors too although the system (e.g., control unit) will apply preferential ranking algorithms to those vendors with more experience and/or better user feedback.

Systems provided by the present invention utilize artificial intelligence to ‘learn’ about user preferences and personality through conversation-like exchanges.

In yet another embodiment, users are able to configure their preferences, attributes, and interfaces (collectively “preferences”) through a “helm” (e.g., analytical dashboard, see FIG. 9, working in conjunction with the control unit) which provides central access to all the related parameters. They may either work in the helm in a ‘novice’ or ‘advanced’ user mode.

The system may have GPS capabilities to allow users with GPS-enabled devices to have the benefit of the system's location-aware functionality.

In one additional embodiment of the present invention, users have the ability to view historical data feed information and trends.

The functions, features and images of the system can also be configured, packaged and/or implemented as a screensaver.

### BRIEF DESCRIPTION OF THE DRAWINGS

FIG. 1—Process flow diagram for the invention;

FIG. 2—Starfish example theme with sample categories;

FIG. 3—Starfish example theme showing changed statuses;

FIG. 4—Flower example theme with sample categories;

FIG. 5—Button example theme;

FIG. 6—Meta-command™ example using fish food;

FIG. 7—Drill-down capability example;

FIG. 8—Drill-down capability graphic;

FIG. 9—Helm (advanced user view) graphic;

FIG. 10—Alert notification graphic; and

FIG. 11—A system according to one embodiment of the present invention.

### DETAILED DESCRIPTION OF THE INVENTION

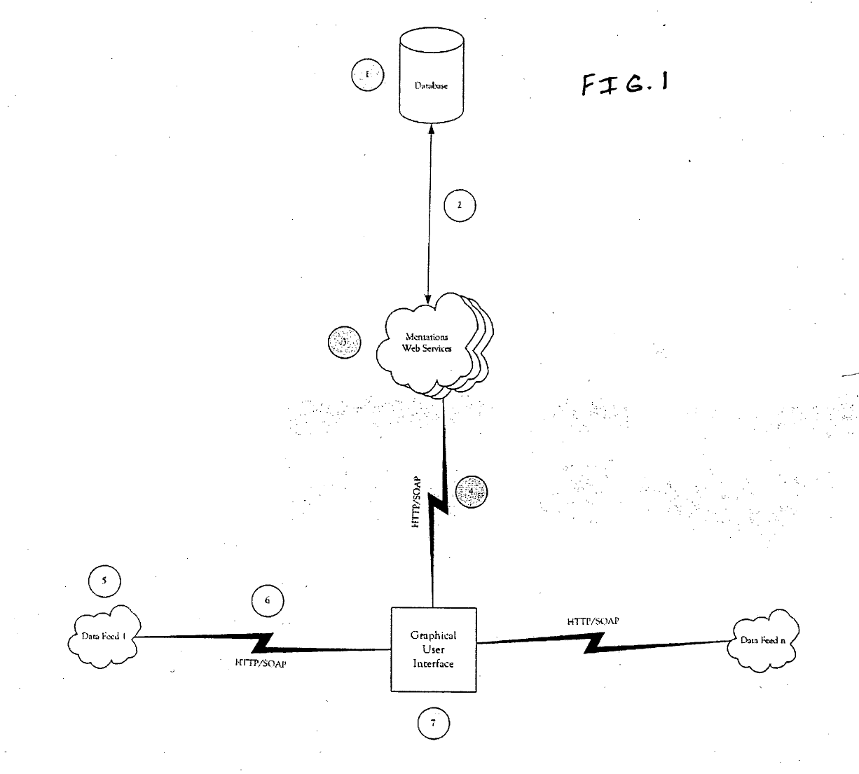

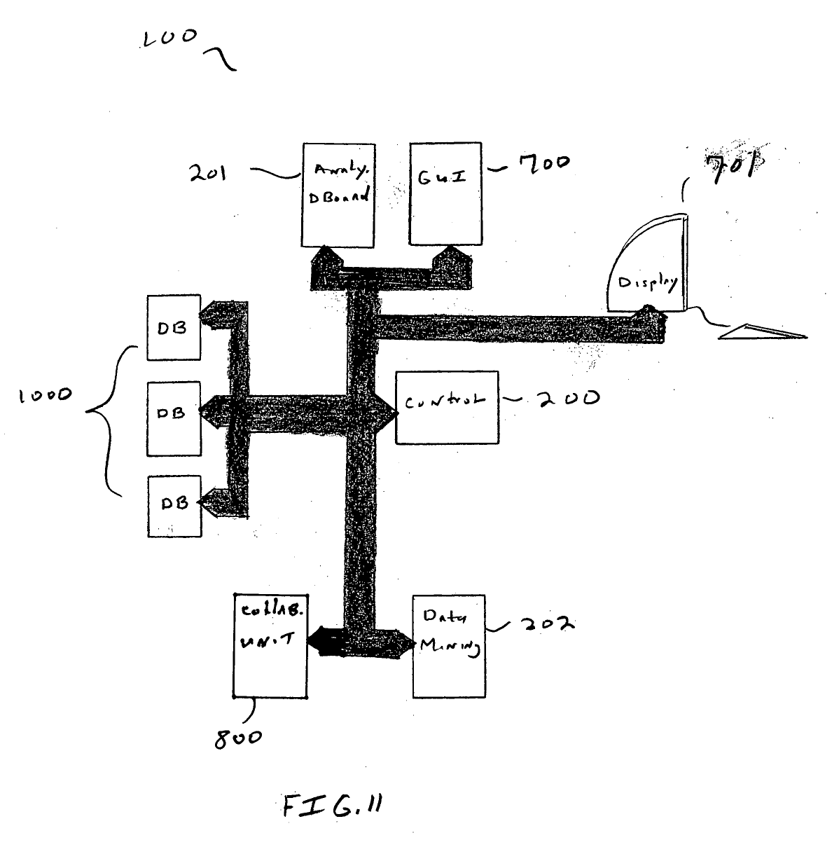

The present invention seeks to deliver aggregated, distilled information to individuals in a concise manner, and allow interactivity with it. FIG. 1, depicts a flow diagram detailing how this process may proceed. First, in one embodiment, a given user's predefined information configuration settings will be made available from one or more databases 1000 (see FIG. 11) through a set of web services 1,2,3 (FIG. 1). That information will then be requested by a client 7 and will be transmitted using a combination of different communication protocols. In one embodiment, these protocols may be formatted using Hypertext Transfer Protocol (HTTP) coupled with the Simple Object Access Protocol (SOAP) 4. These retrieved settings will then be used by the client to query various data feeds of interest at regular intervals 5,6. This information can relate to anything of interest/importance to a given user, from antique cars to investment portfolios to the condition of various military equipment. In addition, information may also be retrieved from web services providing specialized data such as GPS positioning and instant messaging services. A system 100 (see FIG. 11) may be a part of a variety of different devices including, but not limited to, a Personal Digital Assistants (PDA), desktop, laptop, or tablet PC.

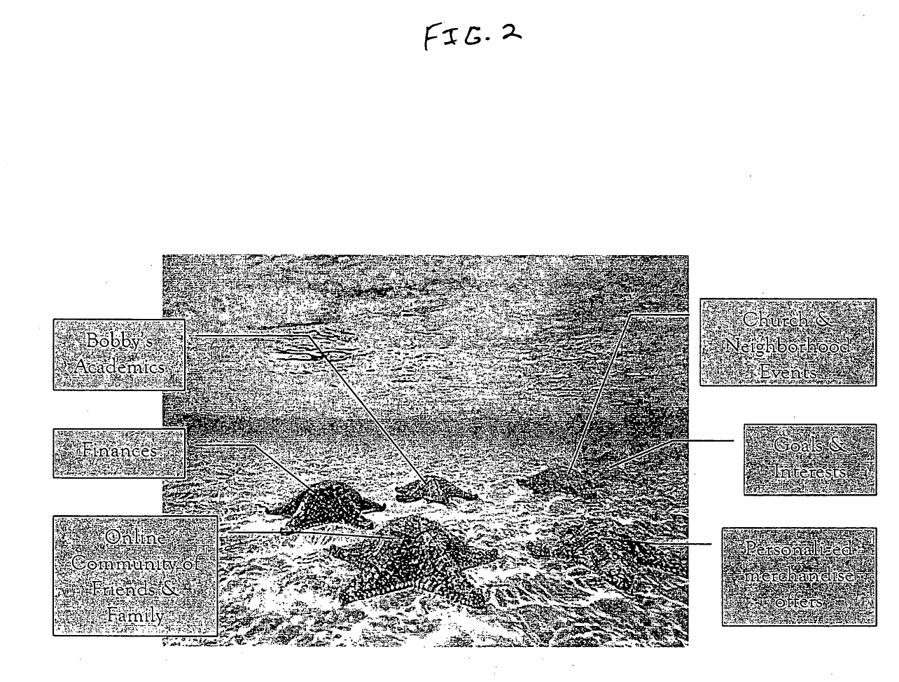

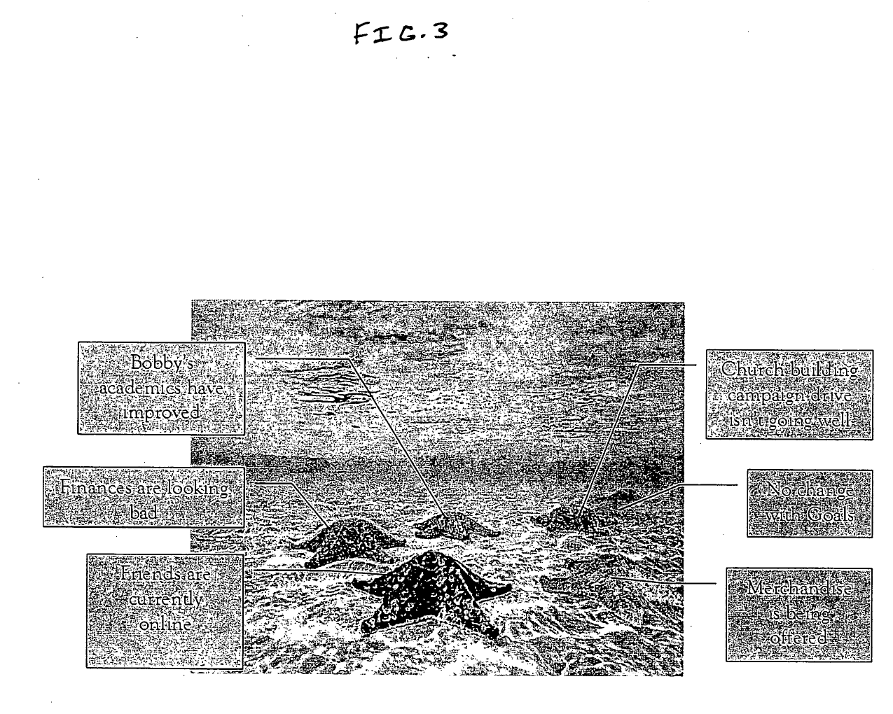

FIG. 2 depicts an example theme that might be employed. It shows how various starfish have been mapped to different information categories. In this example, categories for a child's Academics, Finances, Friends & Family, Church & Community, Goals & Interests, and Merchandise Offers have been established. As the statuses of these categories change, the mapped elements (starfish images in this case) will exhibit different behaviors accordingly (see FIG. 3). The user may define what behaviors should be associated with what status for each category. These behaviors include things like (but is not limited to) sound, movement, size, transparency, appearance (image variations), position, and even smell (as technology permits). As an example, the Finance Starfish is displaying a glowing behavior to represent the condition that the finances category is not doing well.

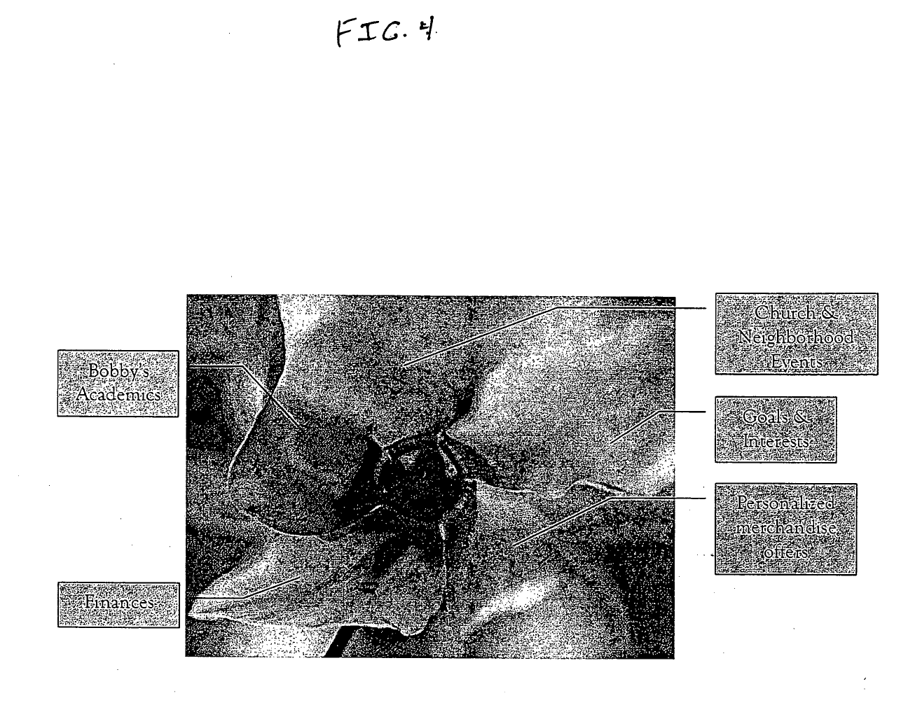

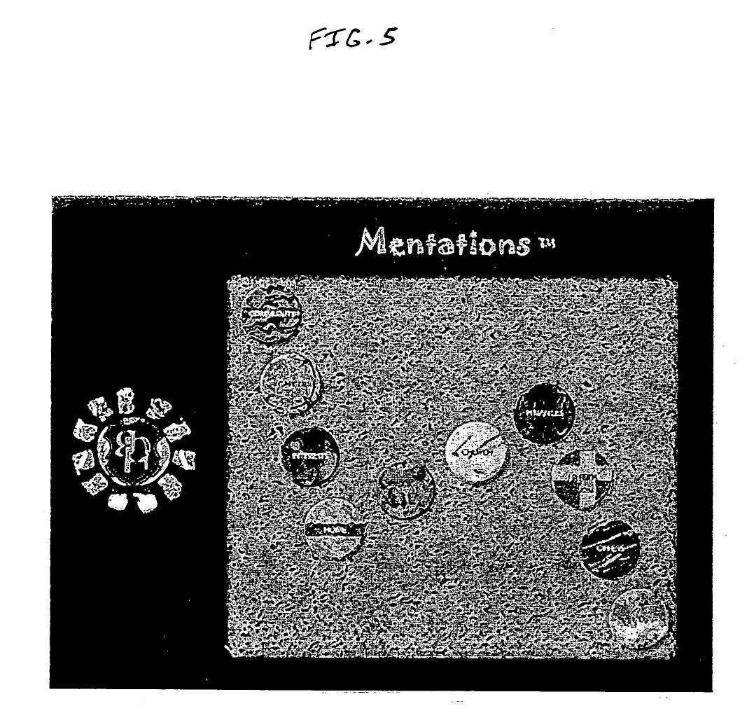

FIG. 4 shows how a control unit may map the same categories shown in FIG. 2 to elements in a completely different theme for the same user, in this case, a flower. In one embodiment, the user may use different themes to display a different look and feel for the same categorical mappings. However, it is important to note that the user could also elect to use different themes to represent different categories as opposed to the same ones. In this way, users can associate different views of their lives with the motif that they feel most comfortable with representing those facets. As an example, FIG. 5 shows a superset of the categories shown in FIGS. 2, 3, and 4 mapped to a button theme. These categories include Community, Career, Interests, Home, News, Church, Finances, Friends, Offers, and Kids. It is quite plausible that the same user could use this theme to give them a slightly different look at their categories.

It is the intent that these themes provide a ready means for users to be able to check at a glance how they stand in relation to the categories they have defined with the realization that users will select certain categories to be more important based upon dynamic criteria, two of which are location and time. As a result, not only will systems provided by the present invention react to changing categorical statuses, but also as a result of changing times and locations. For instance, based on predefined user instructions, the system may display the Career category predominantly during weekday mornings, Academics predominantly during weekday evenings, Finances predominantly all day on Saturdays, and Church predominantly all day on Sundays. Also, the level of lighting might change in the theme corresponding to the time of day or night, becoming brightest around mid-day and darkest during the middle of the night.

Furthermore, using GPS information, if the system detects that the user is near a Mexican restaurant and knows that it is 6:00 PM (e.g., a time around which the user likes to eat dinner) and that the user likes Mexican food, it could make their Interests Category provide feedback letting them know about the restaurant's proximity. Another example might be that, using GPS information, the system knows that the user is near a store which has a particular item on sale that the user has indicated they want to purchase; it would then provide feedback to them through the Offers category.

Another way in which the system may behave dynamically is through the use of Fidget Factors™. Fidget Factors™ are optional behaviors that allows the system to perform random or periodic sequences of actions. As an example of Fidget Factors™ in the Starfish Theme, periodically a given starfish might move its arms, ocean waves and the sound of seagulls might be heard, or a boat might be shown moving overhead. In this way, the system will provide an appealing presentation of sights, sounds, and potentially even smells to the user throughout the day and night.

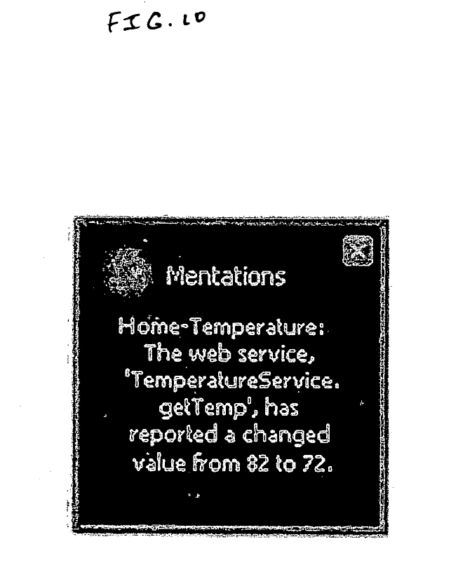

Lastly, users will receive popup alert notifications when the system retrieves new values for various data feeds that are different from the last retrieved information (see FIG. 10). In this manner, the user is constantly aware of how the underlying category data is changing. Users have the ability to click on one of these alerts in order to immediately drill into the associated location within the interface where this information is displayed in detail for further review.

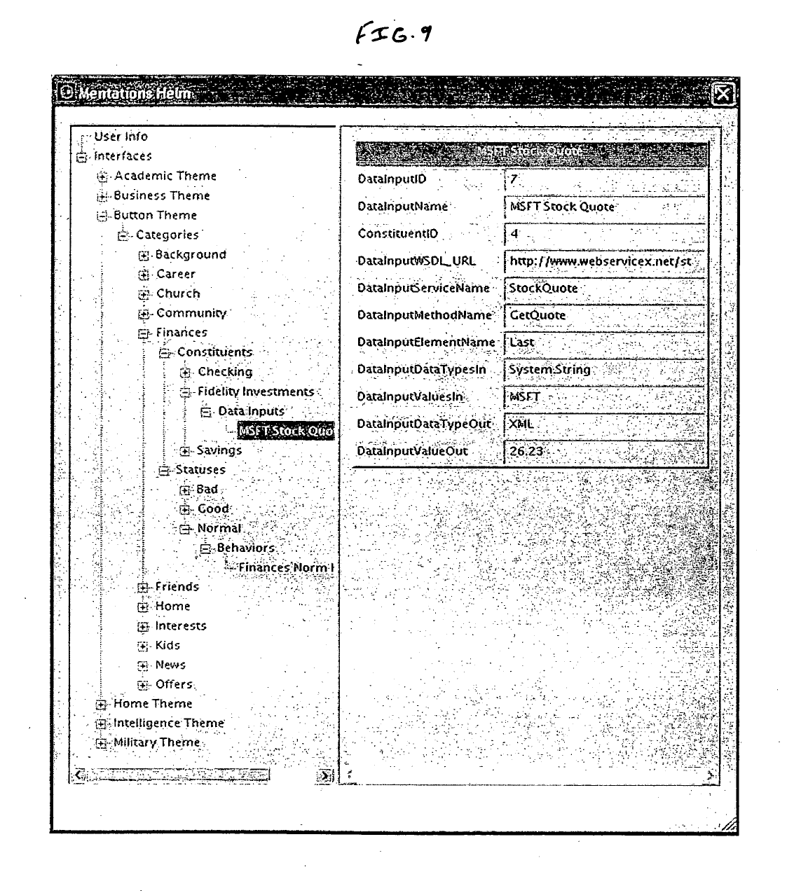

All of the themes, categories, Fidget Factors, etc. may be accessible through an analytical dashboard (see FIG. 9).

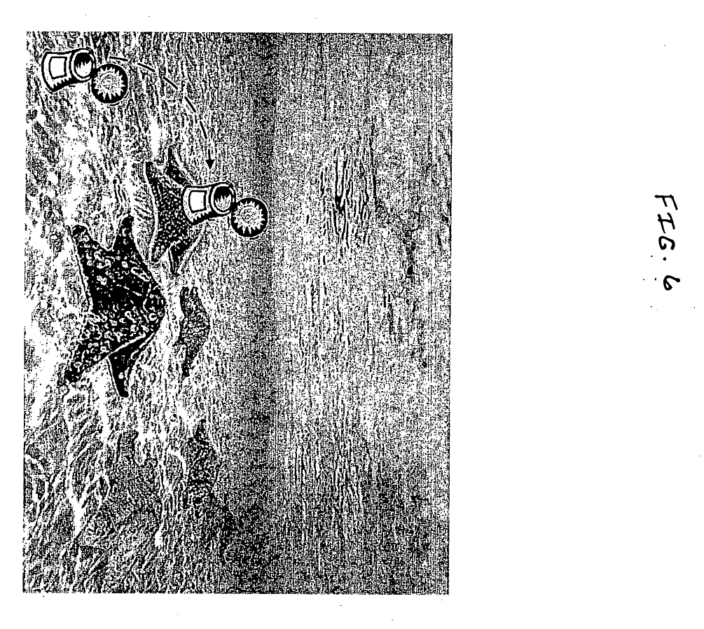

Meta-commands™ are predefined actions that users can create to instruct the system to perform a certain action in relation to their data. These commands may either be defined to be manually or automatically activated. As a manually activated command example, FIG. 6 shows how fish food in the Starfish Theme could be dragged onto the Finance Starfish. The system may be further instructed that if this action occurs, money is to be transferred from the user's savings to their checking account (after prompting the user for their security credentials).

However, because these commands may also be automated, they don't necessary need to map to GUI elements. For instance, the system may have been instructed that if the Finance category's status changes to a bad condition and if the reason is due to a lack of funds in the user's checking account, then funds should be transferred from savings to checking.

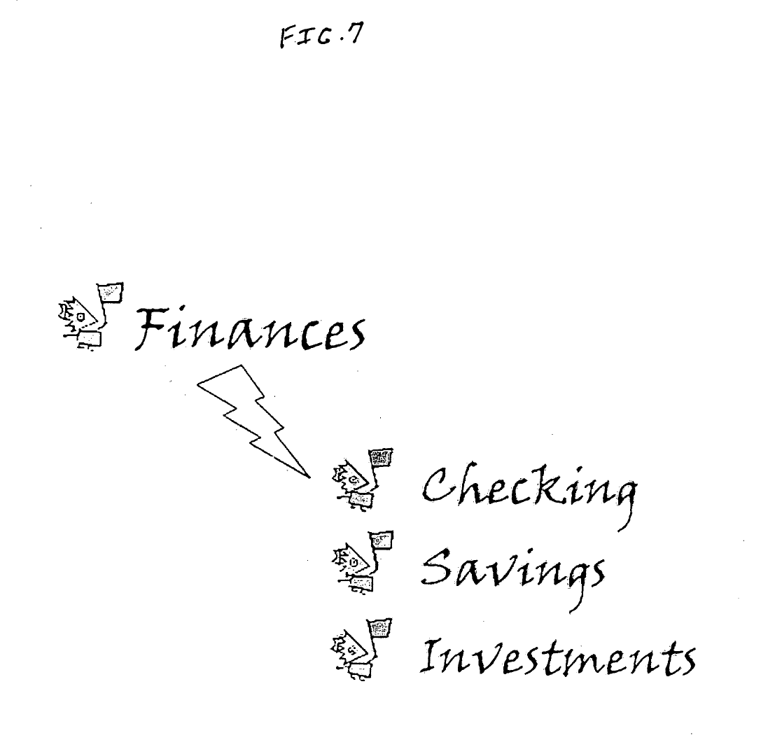

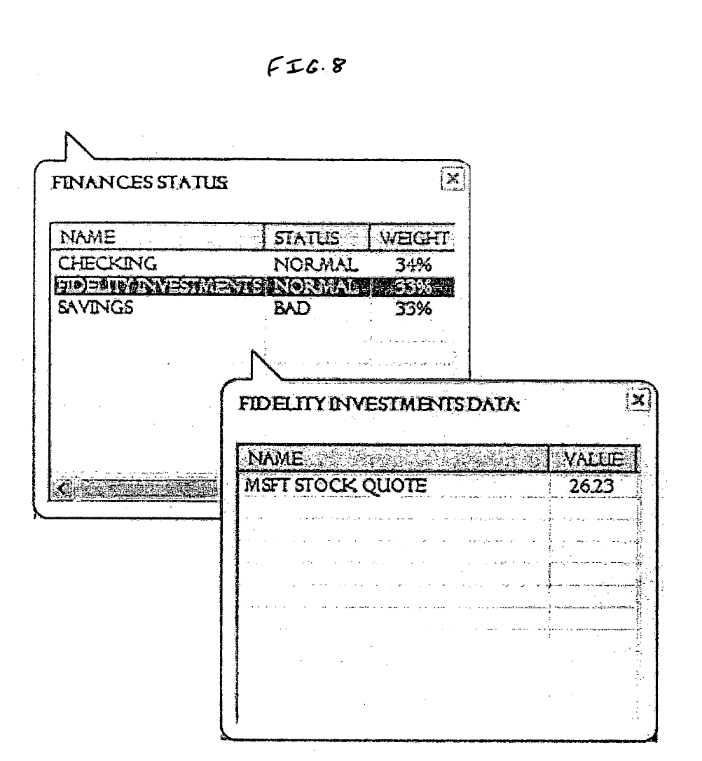

The invention may also allow a user to drill-down into any of the categories they have defined in order to see the underlying statuses of the individual category constituents. As an example, if the Finance category is doing poorly, the user will be able to drill into it (in one embodiment through clicking on the GUI element) to see that the reason the category is in a ‘yellow’ condition (conditions can be defined in a number of different ways) is because the Checking Account status is ‘red’ and the Savings status is ‘yellow’ even though the Investments status is ‘green’ (see FIG. 7). Furthermore, the invention will allow the user to drill-down into the constituent member to see the current value of the individual data point retrieved for it (FIG. 8).

In the drill-down example shown in FIG. 7, each of the constituent members is equally weighted in terms of importance in determining the overall category status. However, this doesn't have to be the case. Individual constituents can be assigned importance weightings from 1 to 100 percent. The only stipulation is that the sum of the weightings for a given category must equal 100. Then, when determining a category's status, the system will use these weightings to determine to what degree a given constituent data point should influence the overall condition.

It should be noted that the system also allows constituents to have ‘Boolean’ weightings. This is important when it is imperative for a given constituent to always determine the overall category status if a certain status is realized. An example would be severe weather alerts. If there is a severe weather alert for a given user's Weather category then the overall category status should always revert to the ‘poor’ condition regardless of the statuses and weightings for the other Weather constituent members.

Users may be required to register before using systems provided by the present invention. For example, a user may be presented with a series of questions regarding their interests, goals, dislikes, demographics, etc. Many of the questions will be optional and can always be answered at a later time through the analytical dashboard or a control panel (see FIG. 9). Periodically the system may engage the user for information through conversation-like exchanges at the user's option. In addition, users will be advised on how to construct their categories of interest along with the component members of each of them. Users will also have the ability to consume predefined system objects like constituents, categories, and interfaces. This information will be stored in a database 1000. Again, it is important to note that the configuration of the system will be dynamic and incremental in nature in that it will proceed much as a conversation occurs. Not all the answers are known at the beginning, but over time through interaction with the system, the user will be better informed and the system will learn about the user's preferences and interests through the system's artificial intelligence algorithms.

System 100 provided by the present invention may also include one or more databases 1000. Within each database 1000 there are stored a plurality of process information to facilitate data mining, the generation of graphical user elements, the display of one or more of the graphical user elements and the configuration of user preferences among other functions. By mining user data, the system will be able to make correlations of one user's interests to other users. The types of process information the system will store and analyze include, but are not limited to, the following:

User demographics;

User-defined categories of information;

Meta-commands™, both automated and manual;

User income ranges;

Time;

Category Statuses;

Personality types;

Sexual Orientations;

Races;

Occupations;

Locations;

Interests, both likes and dislikes;

User goals;

Education Levels;

Marital Statuses;

Relationships to others;

Talents;

Languages.

Through mining the data stored in these various tables a rich understanding of the interrelationships between individuals, vendors, and organizations is achieved. As a result, as the system is utilized, patterns will emerge between these various types of users which will create opportunities for collaboration. As an example, assume you have a friend named Bob who you have designated as a “friend”. The system also knows that both Bob and you like football and live in the Washington, DC area. As a result, while using the system, Bob gets a targeted vendor offer from a ticket broker company offering him tickets to the upcoming Redskins game at a ten percent discount. Bob decides to buy two tickets. The system then gives you a notification that Bob has bought tickets to the upcoming game and asks you if you'd like to buy some tickets too based on your friendship, location, and shared interest in football with Bob. Because of this near real-time, dynamic, intelligent behavior, in a further embodiment, a collaboration unit 800 made up of “tools” may be included in the system to enable the exchange of ideas and information between a user and a relationship (e.g., a friend). These tools may enable instant messaging, discussion boards, and social networking.

It should be noted that an exhaustive description of all the possible embodiments of the invention is not practically possible. However, it should be apparent to those skilled in the art how variations to the invention as described could occur while still adhering to the underlying fundamental concepts of the invention as presented. Furthermore, because the invention recognizes that interfaces/themes are interchangeable and customizable, the exemplary themes shown therein should not be construed as representing the complete population of those that could eventually exist. It should also be understood that the control unit, dashboard, GUI, data mining section, collaboration unit, etc. and their related features and functions may be realized in whole or in part by software, firmware, hardware or the like or some combination of the above.

We claim:

1. A system for visualizing categorized information comprising:
a control unit operable to;
control the storage of a collection of graphical user elements and at least one background image;
control the display of one or more of the graphical user elements within the image to provide a user with a current status of a given information category associated with the element,
wherein the information categories are based on selected user criteria.

2. The system as in claim 1 wherein the criteria comprises at least criteria selected from the group consisting of location and time.

3. The system as in claim 1 further comprising a dashboard operable to configure categories and user preferences.

4. The system as in claim 1 further comprising a data mining unit operable to perform data mining on user preferences and interests.

5. The system as in claim 4 further comprising at least one database operable to store a plurality of process information, said information at least used by said data mining section to perform such data mining.

6. The system as in claim 1 further comprising a collaboration unit operable to enable an exchange of information between a user and a relationship.

7. The system as in claim 1 wherein the image comprises a screen saver.

8. A method for visualizing categorized information comprising:
controlling the storage of a collection of graphical user elements and at least one background image;
controlling the display of one or more of the graphical user elements within the image to provide a user with a current status of a given information category associated with the element,
wherein the information categories are based on selected user criteria.

9. The method as in claim 8 wherein the criteria comprises at least criteria selected from the group consisting of function and time.

10. The method as in claim 8 further comprising configuring categories and user preferences.

11. The method as in claim 8 further comprising performing data mining on user preferences and interests.

12. The method as in claim 11 further comprising storing a plurality of process information, said information at least used by said data mining section to perform such data mining.

13. The method as in claim 8 further comprising exchanging information between a user and relationship.
